(19) United States
(12) Patent Application Publication
(10) Pub. No.: US 2020/0130435 A1
(43) Pub. Date: Apr. 30, 2020

(54) APPARATUS AND METHOD FOR V EHICLE WHEEL-END GENERATOR

(71) Applicants: Jeffrey T. Root, Howell, MI (US); Carl H. Schell, Waterford, MI (US); Lynn DaDeppo, Bloomfield Hills, MI (US); Marcello Tedesco, Fort Gratiot, MI (US); Ehab Kamal, Oro Valley, AZ (US)

(72) Inventors: Jeffrey T. Root, Howell, MI (US); Carl H. Schell, Waterford, MI (US); Lynn DaDeppo, Bloomfield Hills, MI (US); Marcello Tedesco, Fort Gratiot, MI (US); Ehab Kamal, Oro Valley, AZ (US)

(73) Assignee: APPLIED MECHATRONIC PRODUCTS, LLC

(21) Appl. No.: 16/350,278

(22) Filed: Oct. 25, 2018

(51) Int. Cl. B60C 23/12; B60C 23/00; B60R 16/03; H02K 7/18; H02K 7/116

(52) U.S. Cl. CPC B60C 23/12; B60C 23/001; H02K 7/116; H02K 7/1846; B60R 16/03

(57) ABSTRACT

An energy harvesting system is attachable to the wheel-end of a wheeled vehicle. The system generates usable mechanical or electrical energy from the relative motion between a rotating component that rotates with the rotation of a vehicle wheel and a component that does not rotate with the rotation of the vehicle wheel. The usable energy may be employed by a monitor, analysis and control system that monitors sensor readings and may analyze the readings to diagnose conditions related to vehicle components, including tires, axles, bearings or components of the monitoring system.

### RELATED APPLICATIONS

This application claims benefit of U.S. Provisional application entitled, “VEHICLE MONITORING, ANALYSIS, AND ADJUSTMENT SYSTEM,” Application No. 62/707,265, filed Oct. 26, 2017, which is hereby incorporated by reference in its entirety. This application is being filed on the same date as applications having the same inventorship as this application and having the titles “APPARATUS AND METHOD FOR VEHICULAR MONITORING, ANALYSIS, AND CONTROL,” “APPARATUS AND METHOD FOR VEHICLE WHEEL-END FLUID PUMPING,” “APPARATUS AND METHOD FOR VEHICULAR MONITORING, ANALYSIS AND CONTROL OF WHEEL-END SYSTEMS,” and “APPARATUS AND METHOD FOR AUTOMATIC TIRE INFLATION SYSTEM” the entire contents of which are hereby incorporated by reference in their entirety.

### BACKGROUND

Inventive concepts relate generally to a system and method for monitoring and adjusting vehicle characteristics. In particular, inventive concepts relate to a system and method for monitoring, inflating, maintaining tire and wheel related parameters, including air pressure and other parameters, analyzing related data and employing the related data for vehicle operation and maintenance.

Underinflated tires can adversely affect vehicle performance through reduced handling characteristics, lower fuel economy, increased tire wear, road side break downs, etc. However, insuring proper tire inflation is time-consuming and can be a dirty and difficult task. Tire Pressure Monitoring Systems (TPMS) have been proposed as a means of monitoring tire pressure and advising an operator of the state of pressurization in a tire when the pressure is below a target pressure level. Typically, such monitoring systems merely provide an indication of tire pressure inflation level; they do not resolve a tire inflation issue. To address an improper inflation issue, the vehicle must be stationary and proper inflation equipment (both inflation and measuring equipment) must be available, and they often are not.

Although automatic tire inflation systems (ATIS) are available, these systems are costly and difficult to install, particularly for vehicles such as large trucks. Such systems may require specially-ordered attaching equipment, such as custom drive axles. They also, typically, require an extended amount of installation time, making retrofitting an arduous and costly task. These systems do not provide tire status information; they generally maintain targeted tire pressures by pumping air from a reservoir into a tire as the tire's air pressure falls below targeted levels.

### SUMMARY OF THE INVENTION

In example embodiments a wheel-end generator system, or energy harvester, in accordance with principles of inventive concepts may employ a component that rotates relative to the inertial reference frame of a rotating wheel to form what is referred to herein as an inertial power generator. The wheel-end generator may generate usable energy in the form of electrical or mechanical energy (naturally, or both). By “usable energy” we mean energy that is capable of performing work, in electrical or mechanical form, for example, in a wheel-end environment. Such work may include monitoring, analyzing or controlling components or systems in a wheel-end environment. Monitoring, analyzing or controlling may include: monitoring or sampling parameters of a wheel-end environment, such as temperature(s), pressure(s), vibration(s), acceleration(s); analyzing the results of such sampling; and controlling elements or systems, such as wheel-end systems based upon the sampling and analyses. The inertial power generator may generate electrical power for an electronic monitor, analysis and control system in accordance with principles of inventive concepts and may provide power to a mechanical system that provides compressed air to one or more tires associated with a wheel-end.

In example embodiments, with a generator system attached to a wheel-end, as the vehicle moves, a system housing and a portion of the internal workings of the system rotate along with the axle and wheel-end to which it is attached. A portion of the system, referred to herein as an inertial generator, or a portion thereof, does not rotate along with the wheel-end. The differential rotation between the components that rotate along with the wheel-end and the components that do not is employed to generate mechanical power, electrical power, or both. Power storage, such as compressed air (mechanical) or battery storage (electrical), may provide power to a mechanical or electrical system associated with a wheel-end whether the vehicle associated with the wheel-end is moving or not. While the vehicle moves, electrical and mechanical power is generated by the inertial power generator; while the vehicle is stationary, power may be drawn from the electrical power storage.

A vehicle monitoring, analysis, and control system in accordance with principles of inventive concepts may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power from the inertial electrical power generator enables continuous, high-frequency sampling of the various sensors, which, in turn, enables accurate monitoring, analysis and control of vehicle operations. The system may employ the system's detailed sensing, analyses, and diagnostics to provide real-time control of wheel-end functions, such as tire-pressure adjustment (raising or lowering the pressure) and load balancing.

In example embodiments in accordance with principles of inventive concepts a wheel-end energy harvester may be attached to a wheel-end of a wheeled vehicle to generate electrical power, mechanical power, or both. The power may be used to compress air to properly inflate tires associated with the wheel-end, to control distribution of compressed air, and to provide a variety of sensing, analysis, and control functions for a wheel-end and a vehicle with which the wheel-end is associated.

An example embodiment of an energy harvester in accordance with principles of inventive concepts may be included in a wheel-end monitor, analysis and control system in accordance with principles of inventive concepts.

Example embodiments in accordance with principles of inventive concepts include a vehicle wheel-end energy harvester including a non-rotating element; a rotatable element coupled to a wheel; a transmission system including non-circular and non-centered gears; and an engagement element to couple the non-rotating element to the rotatable element, wherein the non-rotating element generates a torque when engaged with the rotatable element and the rotatable element is rotating and the transmission system transmits the torque in the form of usable energy.

Example embodiments include a vehicle wheel-end energy harvester wherein the usable energy is mechanical energy.

Example embodiments include a vehicle wheel-end energy harvester wherein mechanical energy is employed to operate a fluid pumping system.

Example embodiments include a vehicle wheel-end energy harvester wherein mechanical energy is engaged to operate a valve in the fluid pumping system.

Example embodiments include a vehicle wheel-end energy harvester wherein mechanical energy is employed to inflate a tire associated with the wheel-end.

Example embodiments include a vehicle wheel-end energy harvester wherein mechanical energy is employed to deflate a tire associated with the wheel-end.

Example embodiments include a vehicle wheel-end energy harvester wherein mechanical energy is employed to store energy in a reservoir of pressurized fluid.

Example embodiments include a vehicle wheel-end energy harvester wherein usable energy is electrical energy.

Example embodiments include a vehicle wheel-end energy harvester wherein electrical energy is employed to control a wheel-end monitor, analysis and control system.

Example embodiments include a vehicle wheel-end energy harvester wherein electrical energy is stored in an electrical storage system.

Example embodiments include a vehicle wheel-end energy harvester wherein electrical energy is employed to operate a valve in a fluid pumping system.

Example embodiments include a vehicle wheel-end energy harvester wherein a non-rotating element is a weighted pendulum.

Example embodiments include a vehicle wheel-end energy harvesting method including coupling a rotatable element to a wheel; engaging the rotatable element through a transmission system to a non-rotating element; and converting the torque generated by engagement of the rotatable and non-rotating elements to usable energy.

Example embodiments include a vehicle wheel-end energy harvesting method including generating usable energy that is mechanical energy.

Example embodiments include a vehicle wheel-end energy harvesting method including generating mechanical energy employed to operate a fluid pumping system and to inflate or deflate a tire associated with a wheel-end.

Example embodiments include a vehicle wheel-end energy harvesting method including generating usable energy that is electrical energy employed to power an electronic wheel-end monitoring system.

Example embodiments include a wheel-end system for a wheeled vehicle employing inflatable tires including a controller to control the inflation of a tire associated with a wheel-end to which the wheel-end system is coupled; and an energy harvester to supply power to the controller, the energy harvester including: a rotatable element coupled to a wheel; a transmission system; and an engagement element to couple the non-rotating element to the rotatable element, wherein the non-rotating element generates a torque when engaged with the rotatable element and the rotatable element is rotating and the transmission system transmits the torque in the form of usable energy.

Example embodiments include a wheel-end system for a wheeled vehicle wherein the energy harvester generates usable energy in the form of mechanical and electrical energy employed by the wheel-end system to monitor, analyze, and control elements of the wheel-end environment.

Example embodiments include a wheel-end system for a wheeled vehicle wherein electrical energy is employed by a controller to sense wheel-end sensor readings, to analyze those readings and to employ the results of the analysis to control aspects of the wheel-end system, and to provide early diagnosis of state evaluations and prognosis of future wheel end and tire states.

Example embodiments include a wheel-end system for a wheeled vehicle wherein controlled aspects of the wheel-end system include inflation and deflation of a tire associated with the wheel-end.

### BRIEF DESCRIPTION OF THE DRAWINGS

Example embodiments in accordance with principles of inventive concepts will be more clearly understood from the following detailed description taken in conjunction with the accompanying drawings in which:

FIG. 1 is a block diagram of an example embodiment of an energy harvesting system in accordance with principles of inventive concepts;

FIG. 2 is a block diagram of a system employing an energy harvesting system in accordance with principles of inventive concepts;

FIGS. 3-4B are various views of systems employing a plurality of energy harvesting systems in accordance with principles of inventive concepts;

FIG. 5 is a view of example embodiment of an energy harvesting system in accordance with principles of inventive concepts mounted on a vehicle wheel;

FIGS. 6A-6D are views of an example embodiment of an energy harvesting system in accordance with principles of inventive concepts;

FIG. 7 is a detailed view of an example embodiment of a non-rotating, or inertial, element of an energy harvester in accordance with principles of inventive concepts;

FIG. 8 is an exploded view of an example embodiment of an energy harvester in accordance with principles of inventive concepts; and

FIG. 9 is a block diagram of an example embodiment of a monitoring, an analysis and control system that employs an energy harvester in accordance with principles of inventive concepts.

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants' system,” “the system,” “Applicants' method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers or sections, these elements, components, regions, layers or sections should not be limited by these terms. These terms are only used to distinguish one element, component, region, step, layer or section from another element, component, region, step, layer or section. Thus, a first element, component, region, step, layer or section discussed below could be termed a second element, component, region, step, layer or section without departing from the teachings of example embodiments.

Spatially relative terms, such as “beneath,” “below,” “lower,” “above,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

For clarity and brevity of description, inventive concepts may be described in terms of example embodiments related to large trucks. Although the following example embodiments focus on examples within the realm of large trucks, other wheeled vehicles, such as off-road vehicles, lift-trucks, industrial trucks, mining vehicles, automobiles, buses, recreational vehicles (RV's), in fact, any wheeled vehicle, including towable trailers, are contemplated within the scope of inventive concepts.

The terms first, second, third, etc. may be used herein to describe various elements, components, regions, layers or sections. These elements, components, regions, layers or sections should not be limited by these terms. These terms may be only used to distinguish one element, component, region, step, layer or section from another region, step, layer or section. Terms such as “first,” “second,” and other numerical terms do not imply a sequence or order unless clearly indicated by the context. Thus, a first element, component, region, step, layer or section discussed below could be termed a second element, component, region, step, layer or section without departing from the teachings of the example configurations.

In example embodiments a wheel-end generator system in accordance with principles of inventive concepts may employ a component that rotates relative to the inertial reference frame of a rotating wheel to form what is referred to herein as an inertial power generator. The wheel-end generator may generate usable energy in the form of electrical or mechanical energy (naturally, or both). By “usable energy” we mean energy that is capable of performing work, in electrical or mechanical form, for example, in a wheel-end environment. Such work may include monitoring, analyzing or controlling components or systems in a wheel-end environment. Monitoring, analyzing or controlling may include: monitoring or sampling parameters of a wheel-end environment, such as temperature(s), pressure(s), vibration(s), acceleration(s); analyzing the results of such sampling; and controlling elements or systems, such as wheel-end systems based upon the sampling and analyses. The inertial power generator may generate electrical power for an electronic monitor, analysis and control system in accordance with principles of inventive concepts and may provide power to a mechanical system that provides compressed air to one or more tires associated with a wheel-end.

In example embodiments, with a generator system attached to a wheel-end, as the vehicle moves, a system housing and a portion of the internal workings of the system rotate along with the axle and wheel-end to which it is attached. A portion of the system, referred to herein as an inertial generator, or a portion thereof, does not rotate along with the wheel-end. The differential rotation between the components that rotate along with the wheel-end and the components that do not is employed to generate mechanical power, electrical power, or both. Power storage, such as compressed air (mechanical) or battery storage (electrical), may provide power to a mechanical or electrical system associated with a wheel-end whether the vehicle associated with the wheel-end is moving or not. While the vehicle moves, electrical and mechanical power is generated by the inertial power generator; while the vehicle is stationary, power may be drawn from the electrical power storage.

A vehicle monitoring, analysis, and control system in accordance with principles of inventive concepts (described in greater detail, for example, in an application by the same inventors as the instant application and entitled, “APPARATUS AND METHOD FOR VEHICULAR MONITORING, ANALYSIS, AND CONTROL” which is incorporated by reference herein) may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power from the inertial electrical power generator enables continuous, high-frequency sampling of the various sensors, which, in turn, enables accurate monitoring, analysis and control of vehicle operations.

Applicants' system may employ the system's detailed sensing, analyses, and diagnostics to provide real-time control of wheel-end functions, such as tire-pressure adjustment (raising or lowering the pressure) and load balancing as well as predictive measures such as wheel bearing degradation, impending tire carcass delamination, or brake adjuster performance issues.

In example embodiments in accordance with principles of inventive concepts a wheel-end energy harvester may be attached to a wheel-end of a wheeled vehicle to generate electrical power, mechanical power, or both. The power may be used to compress air to properly inflate tires associated with the wheel-end, to control distribution of compressed air, and to provide a variety of sensing, analysis, and control functions for a wheel-end and a vehicle with which the wheel-end is associated.

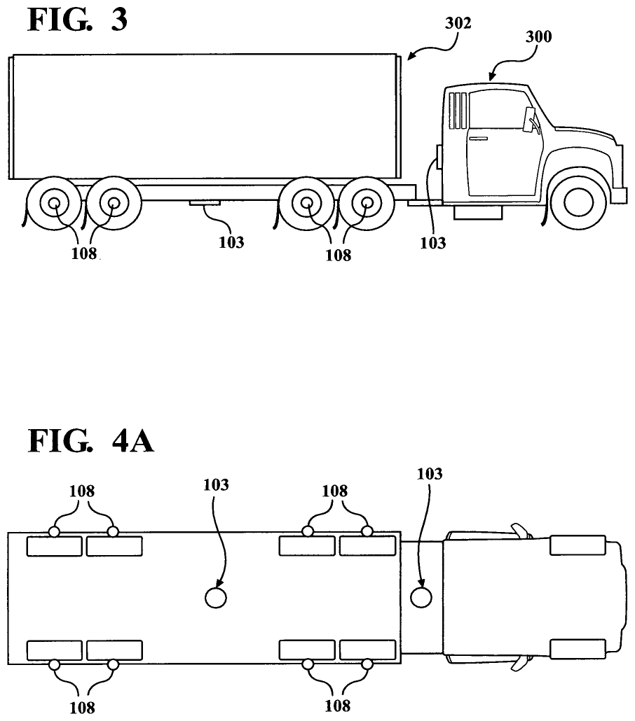

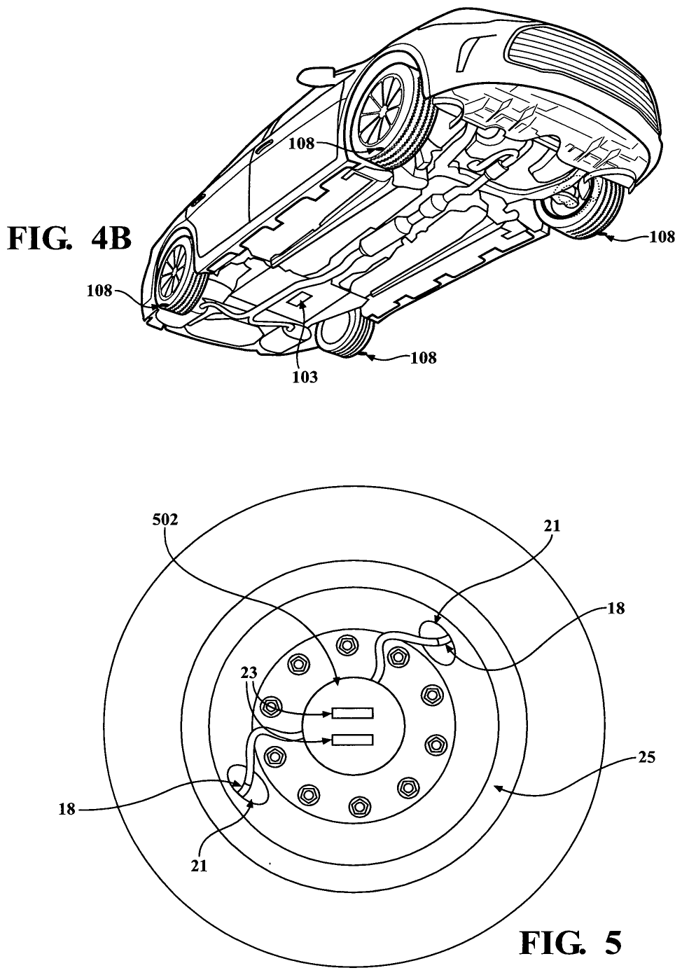

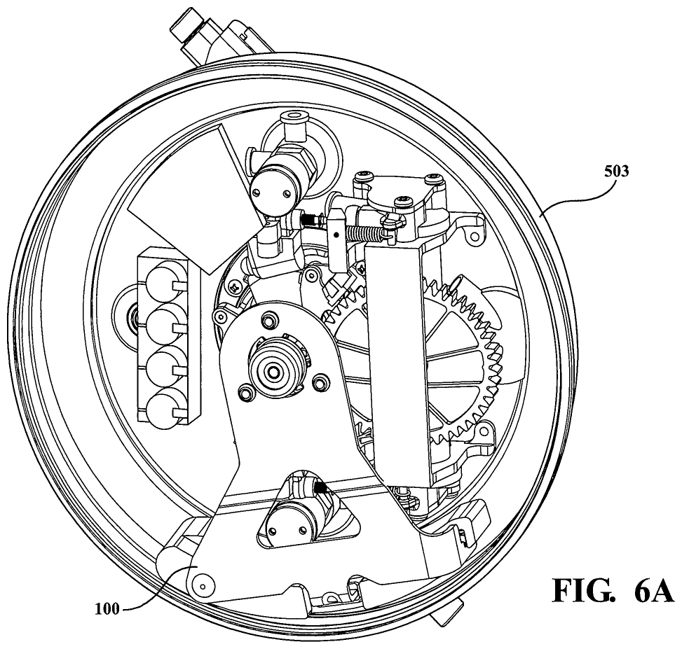

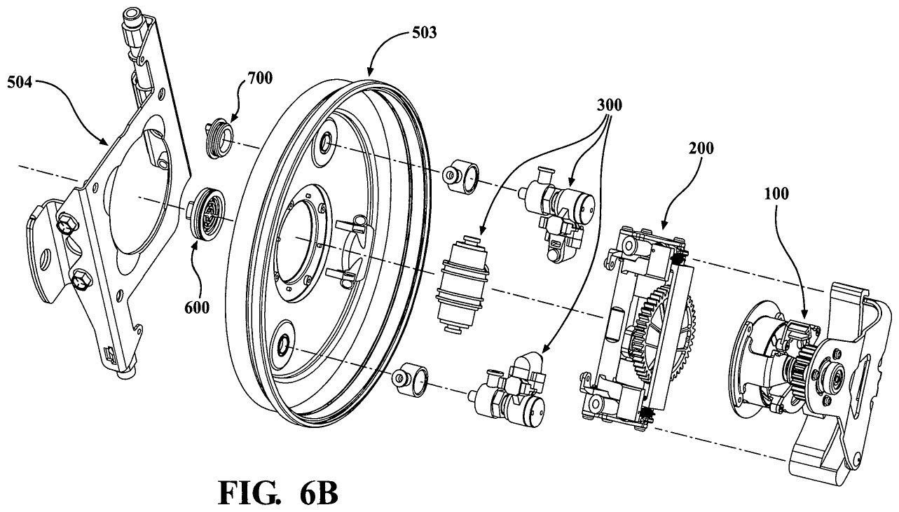

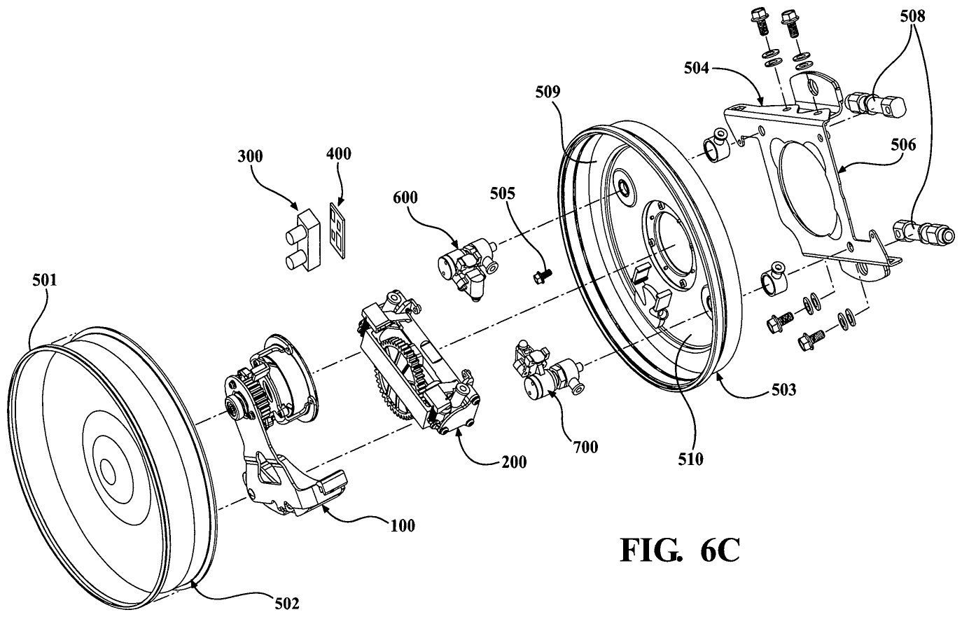

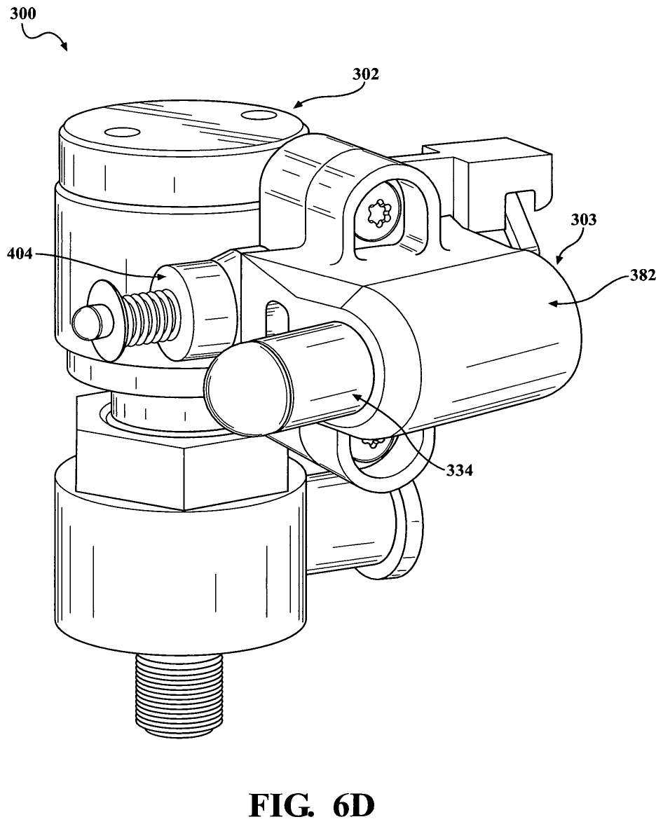

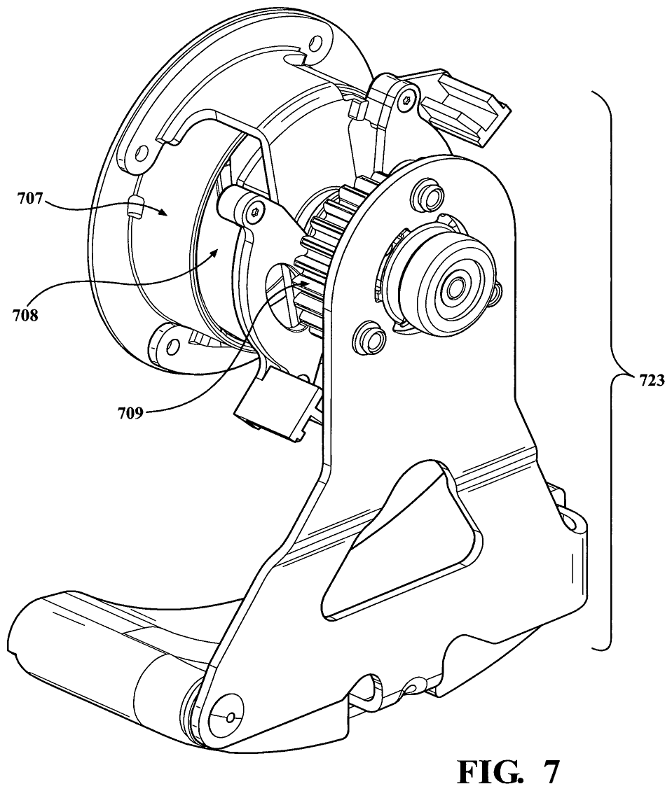

An example embodiment of an energy harvester in accordance with principles of inventive concepts may be included in a wheel-end monitor, analysis and control system in accordance with principles of inventive concepts. FIGS. 3 and 4A provide side and plan view respectively of a semi-tractor 300 and trailer 302. Attached to the hubs of both the tractor 300 driven axles and the trailer 302 axles are wheel-end monitor, analysis and control systems 108. FIG. 4B shows a similar application of wheel-end monitor, analysis and control system 108 to axles on a passenger vehicle. A closer view of the wheel-end monitor, analysis and control system 108 is shown further as may be fastened onto a wheel and tire assembly 18, and more specifically to a wheel 25 in FIG. 5. The wheel-end monitor, analysis and control system shown in assembly in FIG. 6A illustrates the relationship among various components within the wheel-end monitor, analysis and control system, including the energy harvester system 100. As previously noted, energy harvester 100 may be an element of a wheel-end monitor, analysis and control system 108 in accordance with principles of inventive concepts. An isometric depiction of an example embodiment of an energy harvester system 100 is presented in FIG. 7.

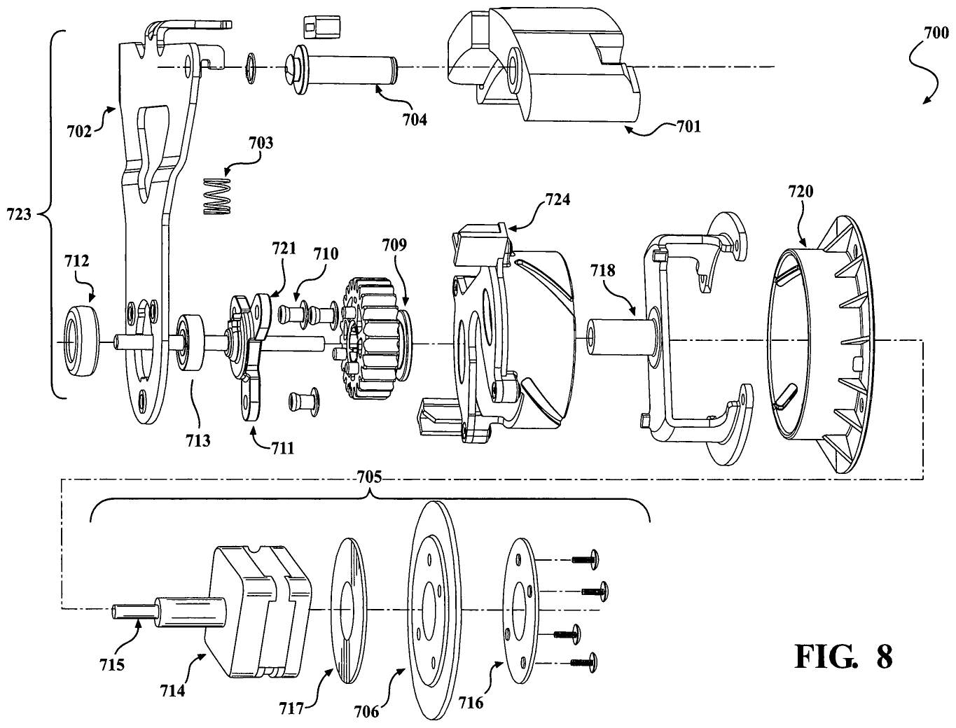

In FIGS. 6A, 6B, 6C and 7, the relationship of the various components that, in example embodiments, constitute this portion of the assembly may be appreciated and will be described in greater detail, for example, in the discussion related to FIG. 8 which provides an exploded view of component elements in accordance with the principles of inventive concepts.

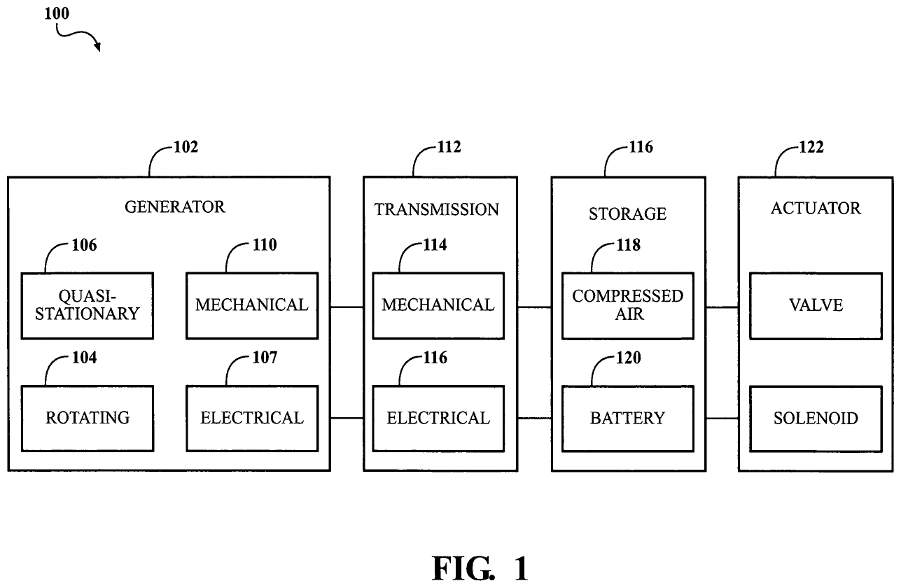

The block diagram of FIG. 1 depicts an example embodiment of a wheel-end energy harvester 100 in accordance with principles of inventive concepts. Energy harvester 100 may be employed with a system that includes rotating elements, such as rotating wheels on a vehicle, to generate mechanical power, electrical power or both. In particular, energy harvester 100 may be employed on a vehicle wheel-end to generate mechanical power to compress air for supply to one or more tires associated with a wheel-end. Electrical power generated by energy harvester 100 may be employed in various monitor, analysis, and control operations, such as those described in an application having the inventors as the instant application, entitled “APPARATUS AND METHOD FOR VEHICULAR MONITORING, ANALYSIS AND CONTROL,” filed on the same date herewith, which is incorporated by reference in its entirety.

In example embodiments monitor, analysis, and control system 108 includes energy harvester 100, which, in turn, includes generator 102, transmission system 112, storage system 116, and actuator system 122. Generator 102 includes a quasi-stationary element 106 and a rotational element 104 that operate to provide mechanical power 110, electrical power 107, or both. Transmission system 112 includes mechanical system 114 and electrical system 116. Electrical or mechanical energy generated by generator 102 are transferred through transmission system 112 to storage system 116, which includes mechanical 118 and electrical 120 storage elements. In example embodiments rotational element 104 rotates along with a wheel or axle as the vehicle with which a wheel-end is associated moves linearly, along a roadway, for example, and quasi-stationary (also referred to herein as “stationary”) element 106 moves substantially linearly, along the same roadway without rotating in the frame of reference of the roadway or vehicle, but rotating in the frame of reference of the vehicle's wheel. Although quasi-stationary element 106 does not rotate along with a wheel with which it is associated, it may, due to torque developed between it and a rotating wheel, for example, make excursions from a directly vertical resting position, but it does not rotate around the wheel's axle.

Mechanical transmission system 114 may employ gears, belts, chains, pumps, valves, or other mechanical components to transfer relative rotation between stationary element 106 and rotational element 104 to storage system 116 (e.g., compressed air reservoir 118) or translate the rotational motion to linear motion to operate a valve or other component in order to inflate or deflate a tire associated with a wheel-end. Similarly, electrical transmission system 116 may transmit electrical energy developed from the relative motion between stationary element 106 and rotational element 104 to storage 116 (e.g., battery 120) or to directly operate components, such as electromechanical valves, to inflate or deflate a tire or to perform other electronics operations as described in greater detail elsewhere.

In example embodiments electrical transmission element 116 may include rectifying, conditioning, and regulating components to provide electrical power at one or more regulated voltages to electrical components, such as an electronic controller, electronic activators such as electromechanical valves or solenoids, electronic sensors, global positioning system (GPS) systems, and communications systems, for example. Mechanical transmission element 114 may include a gearing system to translate rotational energy to linear energy, tubing, valves and pumps to pressurize air for use in controlling and maintaining tire pressurization and equalization, for example.

Mechanical storage element 118 may include one or more reservoirs for receiving and distributing pressurized air. Electrical storage element 120 may be a battery, capacitor, or other element for storing electrical energy provided by generator 102.

A monitor, analysis, and control system 108 in accordance with principles of inventive concepts, which may include energy harvester 100, may be attached to a vehicle's wheel-end to monitor and adjust, for example, the air pressure of a tire associated with the wheel-end to which the system is attached. A plurality of such systems may be employed on a vehicle, with individual systems attached to each vehicle wheel-end. In example embodiments a system in accordance with principles of inventive concepts may include an inertial power generator, a mechanical pumping system and an optional electronic control and communication system. Because the system is attached to a wheel-end, as the vehicle moves the housing and a portion of internal workings of the system rotate along with the axle and wheel-end with which it is associated. A portion of the system, referred to herein as an inertial power generator, or a portion thereof, does not rotate along with the wheel-end.

In example embodiments the inertial power generator includes a quasi-stationary element (also referred to herein as a stationary element) in the form of a weighted pendulum, which is supported by a shaft along a central axis of the system and is free to rotate thereabout. A mechanical coupler (also referred to herein as a transmission system, or, simply, a transmission) couples the quasi-stationary element to the pumping system, which, along with the transmission, rotates with the rotation of the vehicle's wheel. With the coupling and pumping system rotating and the pendulum substantially stationary, the pendulum applies a torque to the transmission, which transfers the torque to the pumping system.

In example embodiments, the weighted pendulum is configured to supply sufficient torque to meet demands. That is, the pendulum is sized to, at one extreme, provide sufficient weight that the pendulum would always remain quasi-static (never move) under torque demands of the system, and at the other extreme, be just a bit more than a mass that would cause the pendulum to spin under a torque demand situation, making the system ineffective. The minimum weight of the pendulum must be sufficiently large to drive the systems within the monitoring, analysis and control system accounting for multiple demands including: pumping, meeting other torque demands of the system (e.g. electrical power generation, start-up torques due to inertia, friction; starting vs. running, etc.), possible parasitic loss developments over the life of the system, as well as a performance margin (safety margin). As noted, the pendulum will have demands that are larger than the steady state running torques and these peak torques will drive the sizing of the pendulum mass. The running torques will fluctuate to some degree, as well. The design of the overall system has been structured to minimize the torque requirements. The system is structured to minimize the torque requirements by minimizing of drive torques, while not violating minimum pumping requirements. This may include gear drive ratios other than 1:1, possibly using a 2:1 average gear ratio, or similar type ratio between the drive gear and the driven gear.

Additionally, to address the fluctuating torque demands, use of a torque transmission system using an elliptical gear system to provide benefits including: added mechanical advantage at the point of highest compression of the compressor, thus reducing fluctuation in the system peak torque demands. The torque transmission system is configured to vary the operational ratios such that the demand for peak torque during the maximum compression period of the pumping process is aligned with an appropriate rotational ratio to allow minimization of torque needed from the drive gear without overly advancing the overall system gear ratio. Maintaining an overall gear ratio as low as possible benefits the system both through the efficient packaging of system components as well as development of a system rotational pumping speed at a faster rate than if a linear gearing system were implemented. As example if the elliptical gearing system varies ratios from a 1:1 ratio to a top need torque demand of 3:1, the equivalent circular system will need to operate to provide the top demand of 3:1 at all times as the ratio is constant. With the elliptical system, the peak will be served with the necessary 3:1 ratio, but on the at lesser load demand segments, a much lower ratio could be employed, the average ratio being lower than the 3:1, thus being faster and more package efficient.

A lighter pendulum mass is beneficial in both the weight saving from the mass reduction of the pendulum itself, as well as, the benefits of lowered bearing and structural loading requirements associated with the lower pendulum mass. The Pendulum mass can be optimized by reducing the level of demand torque required by the system. Beyond the benefits of gearing design identified above, selective operating or shunting of the torque demand elements of the system, mechanical and/or electrical elements will allow the pendulum mass to be kept at a minimum. As example, the electrical or mechanical energy harvesting may be switched off/on or shunted as the alternative mechanical or electrical torque demands cause the pendulum to advance in rotational angle. The reduction in demand will allow the pendulum to return to a perpendicular position. Sensing of pendulum position could be achieved by many methods, including, a Hall Effect sensor system, a potentiometer on the pendulum swing arm, among other means.

Using torque demand switching; peak load smoothing (elliptical gear ratios); and other total torque sizing methods allows reduction in pendulum mass by possibly 50%, with associated package efficiencies. A typical pendulum mass may range from approximately 1500 grams without these countermeasures to possibly 750 grams on a system utilizing torque minimization actions. Using an equivalent package confinement, reduction in mass demands could improve effective torque arm lengths by 30 to 50% based on a circular package confine, further increasing torque system efficiencies. These actions translate into improved durability at a lower weight and allowing the collective weight saved to be applied in the transfer of added vehicle cargo.

In example embodiments, the electrical system may include a power source in the form of a primary or secondary battery. In example embodiments in which a secondary battery is used, the electrical system may employ an electrical generator that is coaxial with a system support, with the generator's stator coupled to the system support (thereby rotating with the rotational portion of the system) and the rotor is coupled to the pendulum, thereby remaining substantially stationary; the relative rotation between the stator and rotor generates electricity. Electricity thus-generated may be used by electronics directly (with normal conditioning) or supplied to an electrical storage system, such as a secondary battery. In embodiments in which a primary battery is used, the battery supplies power to the electronics directly and is replaced as needed.

The electrical system may include a variety of sensors that are monitored by a controller (such as a microcontroller, for example). The controller obtains data from various sensors and processes the data. The processed data may be stored, analyzed and transmitted. The results of analyses may be used by the controller to control the pumping system in order to inflate an associated vehicle tire, for example or may generate recommended actions, that may be either immediate in nature or of a maintenance ongoing nature associated with the state of the wheel-end, axle system or trailer/tractor in total. This information may be transmitted to the driver or a third party using any of a variety of methods.

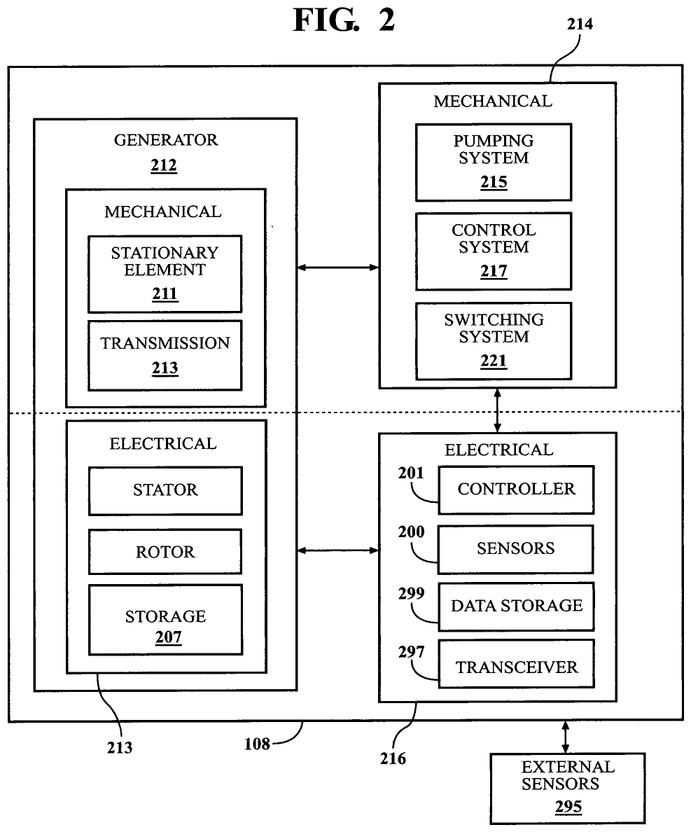

The conceptual block diagram of FIG. 2 provides an overview of an example embodiment of a monitor, analysis, and control system 108 in accordance with principles of inventive concepts that may employ an energy harvester 100 in accordance with principles of inventive concepts. Monitor, analysis, and control system 108 includes a mechanical power generator 212 (which may be the same as generator 102, for example), a mechanical system 214, and electrical power generator 213 and an electrical system 216, all of which may be mounted to a vehicle's wheel-end.

In example embodiments a wheel-end power generator may develop electrical power, mechanical power, or both electrical and mechanical power. The generator may employ a pendulum that remains substantially stationary in the reference frame of the vehicle associated with the wheel-end to which it is coupled (it does not, for example, make a full rotation about a wheel-end axle), but, when the vehicle is moving, because the wheel-end rotates relative to the reference frame of the vehicle, the weighted pendulum rotates relative to the reference frame of the rotating wheel-end. To ensure the safety and stability of the system, of the associated wheel-end, of the associated vehicle, and the public, the weighted pendulum is sized (length of lever-arm, center of mass, etc.) to ensure that the pendulum does not rotate relative to the vehicle reference frame.

In example embodiments, electrical power may be generated continuously by the wheel-end power generator whenever an associated wheel-end is rotating (e.g., the vehicle is moving). The constant stream of electrical power may be used for “real time” operations (e.g., in a wheel-end monitoring, analysis, and control system) and for storing electrical power with which to operate a wheel-end monitoring, analysis, and control system when the vehicle is not moving (and, therefore, the generator is not generating electrical power). When the vehicle is moving and no electrical power is required, either for real-time operation or for storing electrical power (e.g., charging a battery), the electrical power generator may shunt the electrical power to be dissipated by a shunt resistor, for example.

In exampled embodiments, mechanical power may be generated when a vehicle is in motion. In contrast to electrical power generation, mechanical power may not be generated continuously, but may be generated under control of a wheel-end system's self-contained control system. The wheel-end system's self-contained control system may be mechanical, electrical, or a combination of electrical and mechanical. A mechanical power generator may be engaged with a pendulum to generate mechanical power, or disengaged from the pendulum to cease mechanical power generation. When the mechanical power generator is engaged with the pendulum, a torque is generated that may be employed to operate a pump to compress a fluid, such as air, for use in a tire(s) associated with a wheel-end. The compressed air may, in turn, be supplied to a reservoir or tire under control of a wheel-end system's self-contained control system, which may employ mechanical, electrical/electronic, or both mechanical and electrical/electronic control, for example.

Alternatively, the mechanical torque may be continually applied and the control of pumping achieved by the shunting of unwanted air to the surrounding environment. This same shunting means can be used to control the rotational migration of the pendulum as well as used as a starting protocol to counter system start-up torque demands. The mechanical generator may be engaged by translation of a pinion gear and associated connecting pins to engage the pendulum and transmit the resultant torque through the remaining transmission system (e.g., a gear train) to a pumping system that compresses a fluid, such as air, for storage in a reservoir, for example. In example embodiments an elevator translates the pinion gear to engage the pendulum. The elevator may be actuated, for example, by an electrical control system employing a solenoid or motor or, in a mechanical embodiment, by fluid pressure activating an element in the pressure valve. The elevator may have a ramped element that causes elevation when rotated in one direction and “de-elevation” when rotated in the opposite direction.

Referring to FIG. 6D, mechanical activation/deactivation may be accommodated by the pressurization of switching valve 303 causing the movement of activation/deactivation member 334. Activation/deactivation member 334 applies a primarily tangential force in the clockwise or counter-clockwise direction to the elevator element 708, which may result in rotation of elevator element 708. Rotation of elevator element 708 may yield movement of the drive gear 709 containing drive pins 710. The element 334 acts on 724 detail on elevator 708, rotating 708 and lifting it and the pinion gear relative to elevator housing 707 based on pins 718 in 707 riding in cam slot 719 in elevator 708 (see FIG. 8) the reverse action results in the disengagement process. In example, mechanical control, embodiments elevator element 708 may be controlled by the air pressure valve 300, which may be connected to a tire through a port at the bottom of the valve (shown threaded in FIG. 6D. Pneumatic pressure within a connected tire moves the inner workings of the valve. When the pressure drops to a predetermined level (a level set by the spring rate/load check point in the valve), the pressure control valve will move and contact the elevator, which, in turn rotates the elevator and engages pins to the pendulum. When a target pressure is reached within the tire, the valve is depressurized as a result and the elevator returns to an uncoupled state.

Drive gear 709 may be rotatably unconstrained by the elevator 708. Affixed and/or molded into the drive gear 709 may be one or a plurality of drive pins 710. These pins may move axially with the drive gear 709 and engage (That is, the pin will enter the void or hole or indent in the socket plate and then remain in the quasi stationary state with the pendulum, thus transmitting torque to the rotating driven gear and the rest of the pumping system with an attaching socket plate 111.

In example electrical embodiments, a solenoid (or other element) causes the elevator to rotate in one direction or the opposite direction to thereby move a pinion gear axially that thereby engages pins with the pendulum, thereby producing a torque that is used to compress air. That is, the elevator can be operated by various means, the function of the elevator member is to move the pinion axially from an unengaged to an engaged state (and vice versa) with the pendulum. A ramp and pin arrangement in the elevator and associated housing provide the axial movement of the gear with a rotational movement of the elevator. In alternative embodiments, a ramp under the gear may be employed to do the same thing, but the rotating collar is more package-efficient.

In example embodiments employing both mechanical and electrical power generation, with tire pressures at target levels, a mechanical power generation system may be off, while, at the same time, the electrical power generation system is on and the electrical power is used by the system to sense, analyze and control wheel-end systems and variables. With the wheel-end system rotating at an appropriate speed, within a predetermined range, for example, both electrical and mechanical power generators may be operating to provide electrical energy for sensing, analysis and control and for supplying compressed air to a tire that may be under-pressurized, for example. When the pendulum, or energy harvester, is inclined with respect to the vertical beyond a threshold level, indicating that excess load in the form of both mechanical and electrical energy generation is being experienced, one or both of the energy generators may be disengaged or shunted with priority given to supplying mechanical energy to a tire in need of compressed air. In example embodiments, when pumping begins, thereby introducing heavier mechanical loads (e.g., inertial effects, static friction, dry seal drag, etc.,), the system may be dedicated to generating only mechanical power until startup loads are eased (e.g., running friction, rather than static friction) and electrical power is also generated, At very low rates of rotation, when the vehicle is moving very slowly, the mechanical power generators may be turned off.

Power generator 212 includes quasi-stationary element 211 (a weighted pendulum in example embodiments), which is supported along a central axis of the system on a system support shaft and is free to rotate thereabout. Although free to move about the axis of a shaft, quasi-stationary element 211 remains substantially stationary in its own reference frame while rotating about the shaft in the reference frame of a substantial portion of the monitor, analysis, and control system 108. Quasi-stationary element 211 may also be referred to herein as stationary element or pendulum, for example. Transmission 213 couples pendulum 211 to mechanical pumping system 215 and mechanical switching system 221, which, along with transmission 213, rotates along with the rotation of the vehicle's wheel.

With the transmission 213 and pumping system 215 rotating and pendulum 211 substantially stationary, the pendulum 211 applies a torque to the transmission 213, which transfers the torque to pumping system 215. The mass size and configuration, and the lever arm length of pendulum 211 are chosen to deliver sufficient torque for pumping and electrical generation through a wide range of a vehicle's operating speeds, without excessive travel of the pendulum. In example embodiments power generator 212 includes an electrical generator 213 and electrical storage 207 (also referred to herein, simply, as a “battery”), used to power electrical system 216. In example embodiments, electrical generator 213 is coaxial with a system support shaft, with the generator's stator 205 coupled to the system support (thereby rotating with the rotational portion of the system) and the generator's rotor 203 is coupled to the pendulum 211, thereby remaining substantially stationary; the relative rotation between the stator 205 and rotor 203 generates electricity. As described in greater detail in the discussion related to FIG. 8, in an example embodiment that includes electrical power generation and control, a generator's rotor is coupled to pendulum 211, with, (see FIG. 8), rotor shaft 715 press fit into element 711, which is bolted to plate 702, the pendulum arm. With the rotor affixed to the pendulum assembly and the stator affixed to the unit housing (and, consequently, the vehicle wheel), the stator and rotor will experience relative movement whenever the vehicle is moving. This relative movement will generate electrical energy, which powers electronic elements of an electronic monitoring, analysis and control system. Electrical control may include the operation of solenoids or other electromechanical elements that operate to engage or disengage the previously described elevator to thereby provide compressed air, for example, to a tire according to control processes of an electronic controller.

Mechanical system 214 includes mechanical control 217 (including mechanical switching 221), pumping 215, and filtration 219. Mechanical control system 217 engages transmission 213 with pendulum 211 within a range of operational parameter values and disengages transmission 213 from pendulum 211 outside that range. Pumping system 215 translates rotational movement provided by transmission 213 into linear movement used to operate pistons that compress air for use in maintaining proper tire pressure.

Electrical system 216 may include a controller 201, which may be embodied as microcontroller, or microprocessor and various support electronics, for example. Controller 201 may obtain data from a variety of sensors 200 and operate upon the data for a variety of analytical, control, storage, and transmission functions, as will be described in greater detail below. These sensors may include sensors internal to the monitoring, analysis and control system unit as well as those that may be external to the unit, sensors 295.

FIG. 3, illustrates, in side view, a plurality of monitor, analysis, and control systems 108 configured on a vehicle 300. In this example embodiment, the monitor, analysis, and control systems 108 are mounted on motored vehicles 300 or trailered units 302 (a tractor 300 and semi-trailer 302 in this example embodiment). The monitor, analysis, and control systems 108 are shown installed on all powered and trailered (non-powered) wheel assemblies, though a combination of installed and not installed on some wheel assemblies is contemplated within the scope of inventive concepts (for example, installed on powered axles only, or installed on trailered (non-powered) axles only, or installed on a combination of both trailered (non-powered) and powered wheels or as depicted in the illustration). The monitor, analysis, and control system 108 are installed on wheel-ends and provide a distributed set of vehicle monitoring, analysis, and control systems that, among other things, provide tire pressure monitoring and automatic tire inflation.

In example embodiments, each monitor, analysis, and control system 108 may operate autonomously to monitor and adjust vehicle attributes, such as tire pressure, associated with the wheel-end to which they are attached. Additionally, each monitor, analysis, and control system 108 may store, process, analyze and transmit or receive information (that is, raw data, analytical results or commands, for example) associated with the wheel-end to which they are attached. Such information may be shared with a central processor, or hub, 103 connected to, or associated with, a vehicle (located in either tractor 300 or trailer 302, for example) or one of the monitor, analysis, and control system 108 may operate as a central processor or hub. Each monitor, analysis, and control system 108 may provide vehicle monitoring, analysis, and control, including, for example, tire pressure monitoring and pressure adjustment for both single and multiple tire combinations as might be configured on a given wheel-end.

Hub 103 may forward sensed, calculated, or analyzed information generated and/or obtained at the monitoring, analysis and monitor, analysis, and control system 108 to vehicle operators or logistics/maintenance providers as is instructed or designated by the hub 103, for example.

FIG. 4a is a plan view, schematic representation displaying monitor, analysis, and control system 108 on both motored 300 and trailered (non-powered) 302 vehicles. (FIG. 4b depicting a similar passenger vehicle representation). A hub unit (103) may be positioned on the motored vehicle 300 or on the trailered vehicle 302. The transmitter/receiver, or hub, unit (103) may communicate between the individual or collective monitor, analysis, and control system 108 with the world external to monitor, analysis, and control system 108, for example, as determined by preset protocols defined during the set-up of the system. Programmable system parameters may include, but are not limited to: alert notifications, including the type of item to alert, what person/entity to notify; system parameter settings, including tire pressure setting, security setting (e.g. password, type of unauthorized removal actions, etc.); and systems to activate, including system performance monitoring, diagnostic systems, prognostic systems, for example. In example embodiments, the programming/set-up of the monitor, analysis, and control system 108 may be performed via a base unit or, for example, via an application as installed on a portable device such as a smart phone.

FIG. 5 is a close-up view of an example embodiment of a monitor, analysis, and control system 108 in accordance with principles of inventive concepts fixed to a wheel 25. The monitor, analysis, and control system 108 may provide connection to a compressed air reservoir or plurality of compressed air reservoirs or connection to a tire 19 or plurality of tires, which may be made through separate fluid transmission devices. These fluid transmission devices may be tubes, hoses (“hose,” 18 as depicted in the FIG. 5 and as referred to hereinafter), or other types of fluid transfer devices connecting monitor, analysis, and control system 108 to the outer and inner tires 19a, 19b (illustrated on the rear tires of trailer 302 in FIG. 4a, for example) by way of the air inlet port or valve 21 on each of the tires. The monitor, analysis, and control system 108 end of the hose 18 may connect to ports 22 on monitor, analysis, and control system 108. The ports 22, in turn, may be connected to controls or sensors within monitor, analysis, and control system 108 that may monitor or adjust the air pressure of the tires if the monitor, analysis, and control system 108 detects parameter values outside of targeted value ranges, for example. In example embodiments, the tire health monitoring and parameter-altering may be carried out while the vehicle is in motion and does not require the vehicle to be brought to a stop for either the monitoring or the parameter adjustment to occur.

FIGS. 6A, 6B, and 6C are plan, exploded, and exploded views, respectively of mechanical components of an example embodiment of a monitor, analysis, and control system 108 in accordance with principles of inventive concepts. The exploded view depicts several component systems of or within the monitor, analysis, and control system 108 (electrical/electronic components and their operations will be described in greater detail elsewhere). A housing and mounting system 500 may include a top cover 502 and a bottom cover 503 that encompass the inner working of the monitor, analysis, and control system 108 elements. A retaining member 501 may hold the components in place. The retaining member 501 may provide a means of securing the two covers together in a compact manner and may also provide a means of insuring system tamper resistance, for example. The construction of the retaining member 501 may be such that once secured to the two outer covers 502 and 503, removal of the retaining member 501 may require severing (destruction) of the retaining member 501, thereby denying access to the monitor, analysis, and control system 108 inner workings to anyone other than the manufacturer of the unit or other authorized personnel.

Collectively, the three members: bottom cover 503, top cover 502 and retaining member 501, may provide shielding for the monitor, analysis, and control system 108 internal components and systems from exposure to the external elements. The enclosure may contain a lubricant which may be of liquid or powder form, for example. In example embodiments, the rotation of monitor, analysis, and control system 108 (as an associated wheel rotates), as well as the operational performance of the elements within the monitor, analysis, and control system 108, may provide for the distribution of the lubricating material within the assembly. Such lubricant may provide a low-friction surface on relative-motion contacting members, lowering operating friction and reducing associated surface wear or improving system durability.

The top cover 502, in addition to being part of the monitor, analysis, and control system 108 enclosure, may also have mounted onto its outer surface solar cells. The solar cells may be connected to the electrical system within monitor, analysis, and control system 108 and may provide supplemental power to monitor, analysis, and control system 108, particularly when the vehicle is stationary or when monitor, analysis, and control system 108 may be demanding power supply in excess of the monitor, analysis, and control system 108 main electrical power generation capability. The top cover 502 may also have mounted into its surface one or more clear areas, which may be used to display the state of inflation of each associated tire. As previously indicated, a user interface may include, for example, input and output, such as audio input and output, displays, keypad entry for communications with authorized personnel.

The bottom cover 503 may provide the means of attaching or retaining the overall monitor, analysis, and control system 108 to the wheel hub via attachment to the intermediate attaching bracket 504, using bolts 505 and fastening nuts 506 or other fastening means. The intermediate attaching bracket 504 may attach to the wheel mounting bracket 506 using, for example, bolts 507. The wheel mounting bracket 506 may provide attachment of monitor, analysis, and control system 108 to a wheel using the wheel's attaching studs and nuts (not shown).

In example embodiments, the lower cover 503 may have attached within it a housing magnet 512 and a magnetic trigger pairing sensor 514. The wheel mounting bracket 506 may have a wheel mounting bracket magnet 513 attached to the attachment of monitor, analysis, and control system 108, including the attaching bracket 504, to the wheel mounting bracket 506 may yield a magnetic pairing of a housing magnet 512 to a wheel mounting bracket magnet 513. The aligning or pairing of these magnets may activate a signal that is detectable by a magnetic trigger pairing sensor 514. Such a device may be used to detect authorized/unauthorized removal of monitor, analysis, and control system 108 from the vehicle. Authorized removal may occur through the activation of an authorization code via the base unit, smart phone, or other authorized data submission method, for example. The code will advise the unit to expect an unpairing of the magnets. Should an unauthorized monitor, analysis, and control system 108 removal be detected, a system in accordance with principles of inventive concepts may respond in a variety of manners, including, but not be limited to: disabling monitor, analysis, and control system 108 and not allowing functionality, setting all ports to discharge, which may result in the system not maintaining pressure and sending alerts to pre-defined entities indicating that the monitor, analysis, and control system 108 is being/has been removed, for example.

The intermediate bracket 504 may also provide attachment and positioning for hose fitting 508 or other type fluid transfer fitting. Hose fitting 508 may provide an interface between the air/fluid transfer system within monitor, analysis, and control system 108 and the hose assembly 18, which, in turn, may provide one of a variety of connections from monitor, analysis, and control system 108 to the tire pressure valve 21. In example embodiments, fitting 508 may have a threaded end compatible with a threaded fitting on the hose assembly 18 and may be securely attached to the hose assembly and the lower cover 503, thereby providing an air-tight fluid conveyance from monitor, analysis, and control system 108 to tire valve 21. The lower housing may also provide attachment for air filtering system and a battery system 700.

In example embodiments in accordance with principles of inventive concepts an electrical storage device may be employed to store electrical energy for operation of a monitor, analysis, and control system 108 controller or other electrical components. In example embodiments, the electrical storage device may be a battery (either rechargeable or non-rechargeable) or other electrical storage devices such as capacitors, flywheels, or super-capacitors, for example. The electrical storage devices (also referred to herein, simply, as battery) may be used solely or as a supplement to electrical power generated by monitor, analysis, and control system 108 to provide power for elements of monitor, analysis, and control system 108 when the system's electrical generator is not generating power or when system power demands exceed the levels of power being generated by monitor, analysis, and control system 108's electrical generator. For example, a battery may be used to power control circuitry when the vehicle and monitor, analysis, and control system 108 are stationary or traveling at very low speeds (and, therefore, the system's electrical generator is not operating at its full capacity) to allow monitoring of system health and to provide other low-power system functionality.

It may be desirable from time to time to remove the battery assembly to allow for the removal or replacement of the battery. In example embodiments, the battery housing may be configured for removal from the monitor, analysis, and control system 108 by a rotational or similar movement of the battery housing relative to a stationary lower cover. A quarter turn and rearward extraction motion of the battery assembly relative to the lower cover may be one such means of removal or replacement of the battery assembly.

An example embodiment of a power generator 102 in accordance with principles of inventive concepts in monitor, analysis, and control system 108 is depicted in FIG. 7 as that portion of the overall system identified as elements contained in system 700, which may be referred to herein as an energy harvesting and power transmitting system. An isometric view of the energy harvesting and transmitting portion of monitor, analysis, and control system 108 is shown in FIG. 7. In FIG. 7, the relationship of the various components that, in example embodiments, constitute this portion of the assembly may be appreciated and will be described in greater detail, for example, in the discussion related to FIG. 8.

The harvesting of energy may occur with the relative rotational movement of the rotatable portion of monitor, analysis, and control system 108 with respect to the inertial mass element 723 within the monitor, analysis, and control system 108. The rotation of monitor, analysis, and control system 108 may be as a result of being attached to a vehicle wheel assembly, which may be in a rotating state as the vehicle is in motion. The energy harvesting and power transmission member 700 within monitor, analysis, and control system 108 may be at a non-rotating state as a result of the inertial mass properties of the energy harvesting assembly 701 and the nearly rotational force free design of some of its elements. Relative motion between the monitor, analysis, and control system 108 and its internal energy harvesting assembly 701 may provide two types of energy harvesting: mechanical and electrical energy.

As relates to mechanical energy, the relative motion of the Energy harvesting assembly 701 to the other elements of monitor, analysis, and control system 108 may result in a torque sufficient in magnitude to power portions of monitor, analysis, and control system 108. FIG. 8 provides an exploded view of an example embodiment of an energy harvesting and transmitting portion of a monitor, analysis, and control system 108 in accordance with principles of inventive concepts. The monitoring, analysis and control system energy harvester, depending upon configuration and feature content, could be configured as a mechanical energy harvester or an electrical energy harvester, or both. The device depicted in FIG. 8 illustrates a mechanical and electrical harvesting device.

The system 708 depicted in FIG. 8 includes an electrical power generating assembly 705. The electrical power generating unit 705 may be mounted such that one portion, the housing assembly 714, may be rotatable relative to another portion of the assembly, the shaft assembly 715. Relative motion, with one element being a stator and another being a rotor may result in the generation of electrical energy. The electrical generating assembly 705 may be mounted to a lower cover of monitor, analysis, and control system 108 through its generator housing 714. The generator assembly 705 may have generator housing 714 configured to provide fastening or fixing capability at one end of the assembly and may have a generator shaft assembly 715 that has provisions for attachment at the other end of the generator assembly 705.

The generator housing 714 may be fixed to the lower housing 503 through an isolating elastomer 706, which may be fitted between two elastomer compression limiting discs 716 and 717. The elastomer may provide a degree of isolation between the cover and the electric generator 705 and also may provide accommodation for some amount of misalignment, which could occur in the assembly of the component elements of the unit, for example. The compression discs 716/717 may provide a level of restriction in the excursion that the generator end may experience from the isolator 706. The other end of the electrical generator 705 may be fastened or fixed through the generator shaft 715. The generator shaft 715 may be fixed or fastened to a socket plate 711 and a bearing 713. The bearing may be of conventional construction or may be of bushing type construction utilizing engineered polymers. The engineered polymer possibly providing both a surface capable of high degree of wear resistance and also stability through the application of both strengthening materials or solid lubricants. The bearing or bushing 713 may, in turn, also be attached or coupled to an inertial mass assembly 723, with an attaching socket plate 711 and a set of attaching fasteners 722.

The generator shaft 715 may additionally be supported by a bearing assembly 712 in which the inner race of bearing 712 may be attached to shaft 715 and the outer race of bearing 712 may be affixed an upper cover. The bearing may alternatively be replaced by a polymer bushing as describe for element 713, where the bushing may be fixed to the upper cover 502 and the shaft 715 may freely rotate within the bushing. This configuration, with either bearing/bushing type, may allow the generator shaft assembly 715, which may be firmly fixed to the inertial mass 723, to rotatably move relative to the generator housing assembly 714, which itself may be rotatably affixed to a lower cover. Relative rotating movement between the generator shaft and the generator housing of the generator assembly may produce electrical power.

Inertial mass unit 723 may include a number of elements as depicted in FIG. 7. The inertial mass unit 723 may be pivotable about an axis A. This axis A may be defined by a line created by the center point of the electrical power generator assembly 705 and the mounting of same into the lower cover 503 and a second point defined by the mounting of the generator shaft to the upper cover 502 via mounting elements as previously described within this disclosure. This axis may also be coaxial with shaft 715 and the vehicle axle with which the wheel-end unit is associated.

Inertial mass unit 723 may include the following elements: a radial support member 702, which may provide a radial member which may fasten and extend from a proximal attachment at/or about the generator shaft 715, the attaching bearing/bushing 713 and attaching plate 711, as previously described. Radial support member 702 may be configured extending from rotatable center axis A to a distal position which may have affixed to it a mass unit 701. The mass unit 701 configured to provide a sufficient gravitational inertial mass to maintain the inertial mass assembly 723 in a quasi-static position relative to the rotational movement of other elements of the wheel-end monitor, analysis and control system.

In example embodiments, inertial mass 701 may be further configured to be contained within the rotatable confines of the upper and lower covers 502 and 503, respectively, during axial excursions, as well. The mass unit 701 may move in a quasi-vertical direction when road loads and/or other impact-induced events occur. These impacts may be directly translated onto the wheel-end monitor, analysis and control system support shaft assembly and/or the electrical power generator device and/or the related support bearings/bushings and/or shaft assembly, for example and/or may result in significant perturbations of the mass unit from its quasi-stationary position. Mitigation of these impacts upon some elements of the wheel-end monitor, analysis and control system may occur, and perturbations of the mass unit may be reduced, as the mass 701 may be pivotably affixed to the support member 702 about an axis B, located on the support member 702. Mass 701 may also be further constrained at a distal position relative to the pivotal axis B by a tuned energy storage element 703, such as a compression spring, for example. The energy storage element 703 may attenuate impact forces experienced by the vehicle and/or subsequently the wheel-end monitor, analysis, and control system 108.

In example embodiments in accordance with principles of inventive concepts, inertial mass unit 723 and, more particularly, the mass unit 701 may have additional road input and/or other impact attenuation capability beyond the energy storage device 703, through the use of a tuned damper and/or absorber 704, for example. When energy with intensity levels beyond that of a determined threshold and/or overall impacting energy beyond the capacity of the energy storage device 703 are encountered, an absorber 704 may be located on support member 702 in such a manner that it may be contacted by the mass unit 701, resulting in an additional level of impact attenuation and thereby further reducing the frequency and intensity of load being transmitted to the other elements within the wheel-end monitor, analysis, and control system 108. In example embodiments, absorber 704 may include voids or may be composed of elastomeric materials (possibly of multiple hardness) in order to provide desired damping characteristics, for example.

The development of mechanical energy achieved through the relative motion of the energy element 723 and other elements of the wheel-end monitor, analysis, and control system 108 may employ a means of energy transmission for use within the monitor, analysis, and control system 108. The transmission elements may be as are shown in FIG. 7 for example. In FIG. 7, elevator housing 707 may be a circular element that may be securely affixed to lower housing 503 with a flange end attachable to the Lower Housing 503 using fasteners 720. Elevator housing 707 may also be positioned on the lower cover 503 so that the center of the elevator 707 may be coincident, or coaxial, with axis A. Elevator housing 707 also may have on its interior surface cam follower pin detail 718, which may be one or more in number. Pin(s) 718 may be molded into elevator housing 707 and/or affixed as uniquely separate elements within the elevator housing 707 at prescribed locations and/or positions and may be of predetermined size and number such that they may interact with related cam surfaces and/or ramps 719 located on the exterior surface of elevator assembly 708.

The elevator assembly 708 exterior may be sized to fit within the elevator housing 707 and, when the housing 707 and elevator assembly 708 are fitted together, may have pins 718 positioned to interact with the cam surfaces 719. The elevator assembly 708 may be rotatably activated from a position 1 to a position 2 or vice versa. The activation of the elevator 108 from position 1 relative to a fixed elevator housing 707 to a rotatable position about axis A to a position 2 within the elevator housing 707 may result in elevator assembly 708 cam surfaces 719 contacting elevator housing pins 718. This contact and/or interaction, may result in an elevation and/or a displacement along an axis A of elevator assembly 708 relative to elevator housing 707.

Elevator assembly 708 may have affixed, and/or may have axially related to it, a drive gear assembly 709 such that as elevator 708 moved along axis A from position 1 to position 2, may interact with drive gear assembly 709 and may result in drive gear assembly 709 moving along an axis A similar distance. The drive gear may move axially with the elevator 708 and both the drive gear and the elevator may be supported by generator shaft 715.

Drive gear 709 may be rotatably unconstrained by the elevator 708. Affixed and/or molded into the drive gear 709 may be one or a plurality of drive pins 710. These pins may move axially with the drive gear 709 and may engage with an attaching socket plate 711. Drive pins 710 may be assembled onto the gear at a radial distance from the center of the gear and positioned such that they could interact with an attaching socket plate 711, with socket holes 721 in radial position and spacing so that they may correspond to the pins 710 within the drive gear 709.

As the drive gear 709 moves along Axis A, drive pins 710 may contact attaching socket plate 711. The wheel-end monitor, analysis and control system system 108, less the Inertial mass assembly 723 portion of the system 108, may be rotating with the vehicles wheel and tire assembly, and the inertial mass assembly 723 may be rotationally quasi-static due to the inertial effects of its mass, and, as a result, there may be a relative rotational motion between the drive pins 710 and the sockets 721 within the attaching socket plate 711. The rotational relative motion of the pins 710 and the sockets 721, in conjunction with the axial movement of elevator assembly 708 toward the attaching socket plate 711, may result in axial coupling of drive pins 710 and sockets 721 in attaching socket plate 711.

Coupling with attaching socket plate 711, being affixed as part of the inertial mass assembly 723, may result in inertial mass assembly 723 constraining the rotational motion of drive gear assembly 709. The constraining of the gear 709 by the inertial mass assembly 723 may cause a relative motion between the drive gear assembly 709 and the other elements of the wheel-end monitor, analysis and control system as the coupling of the drive pins 710 and sockets 721 occurs. In example embodiments in accordance with principle of inventive concepts, this provides a means of transmitting mechanical force and/or torque from the inertial portion of the system to mechanical elements that may be coupled to the drive gear assembly 709. This coupling and related inertial resistive torque may be beneficial in the powering of various devices such as an air compressor or other mechanical devices within the wheel-end monitor, analysis and control system 108 in accordance with principles of inventive concepts.

In example embodiments in accordance with principles of inventive concepts, electrical energy harvesting within monitor, analysis, and control system 108 may be a result of a similar relative rotational motion. An electric motor may output a voltage when it is mechanically rotated, operating as electrical generator. In example embodiments in accordance with principles of inventive concepts, an electric motor may be used in this fashion to generate electrical power for monitor, analysis, and control system 108. In example embodiments, all, or a portion, of inertial mass assembly 723 mechanical rotational energy may be used to drive a motor, such as a stepper motor, to generate the voltage and electrical current desired to provide electrical power needs of monitor, analysis, and control system 108 or similar device. Such a configuration may use a stepper motor 705 with the stator and coils held fixed as part of the housing 714 and the rotor and shaft 715 held fixed to the inertial mass assembly 723 and freely rotating relative to the housing 714, for example. Other motors, such as a Brushless DC (BLDC) motor, Shunt Motors, Series Motors, Permanent Magnet Motors (PMDC), Compound Motors, AC Motors such as Induction and Synchronous Motors and Hybrid Motors such as Hysteresis Motors, Reluctance motors, etc. or any other type of electrical motor or generator, are contemplated within the scope of inventive concepts to generate electrical power.

The power generator assembly 705 may produce a sinusoidal voltage output. Multiple phases of the generator, either combined or singly and either in a filtered or unfiltered state, and in either an AC-like voltage state, or in a Rectified DC state, could be generated in accordance with principles of inventive concepts. Minimal power conditioning of the multiple phases of the sinusoidal voltage may be done for power needed for the higher voltage portion of circuitry, such as, electrical valves, resistive heating elements etc. Additionally, combined phases of the generator processed through either a passive (Resistor/Capacitor/Inductor) conditioning circuit, or a more complex active circuit with diodes (for rectification), and active voltage regulators may provide cleaner DC power sources for electrical operations such as control circuitry, etc. Generator electrical efficiency may be maximized by filtering of generated power, possibly only for the controller (for example, a microprocessor or microcontroller) and associated electronics and may be achieved with Buck/Boost regulators. Minimizing the need/use of conditioned power may allow the use of non-electrolytic capacitor systems and may yield improved system durability.

In example embodiments, power generator assembly 705 generates sufficient power to operate a controller, or main processor (for example, a microcontroller (MCU), a System-on-Chip (SoC), or a Field Programmable Gate Array device (FPGA)). Additionally, resistive circuitry elements (such as, but not limited to, Resistors, or resistive traces on circuit boards) may be employed to convert available current flow into heat, resulting in warming of critical parts of a system to prevent freezing or adverse operating conditions. Additionally, such circuit elements could possibly be used to provide a means of removing excess or unwanted moisture in a system by elevating system or area temperature. This heating may be selective and targeted to a specific area, or may be generalized to a system to maintain a desired overall temperature profile range, for example.

The electrical generator 705 may be secured by the electrical generator housing 714 to a lower cover, as previously described. The electrical generator 705 may, in turn, be attached to the energy harvesting member 723 by attachment of the electrical generator shaft 715 via the socket plate 711 and bearing/bushing 713 to the radial support member 702. When monitor, analysis, and control system 108 rotates relative to the stationary radial support member 702 and associated elements, as previously described, the electrical generator shaft 715 rotates relative to the electrical generator housing 714 this relative motion results in the potential for the generation of electrical energy.

Although a relative motion between the monitoring, analysis and control system generator system 108 and the inertial mass unit 723 is desirable to generate the aforementioned electrical or mechanical power, it may also be possible that vehicle, road or other factor induced inputs to monitor, analysis, and control system 108 could induce undesired oscillations or perturbations of the inertial mass unit 723, possibly aligning the motion of the inertial mass unit 723, to some degree, with the other elements of monitor, analysis, and control system 108. In example embodiments in accordance with principles of inventive concepts, such undesirable oscillations or movement of the inertial mass element 723 of the monitoring, analysis and control system generator system 108 may be minimized or interrupted through the selectively short circuiting of two or more legs of the power generator assembly 705 (e.g. stepper motor), thereby causing a braking type force to occur. This could be achieved through control circuitry by applying solid state switching, such as transistors/bipolar or Field-Effect transistor, etc., or through use of mechanical type switches such as relays, etc., for example.

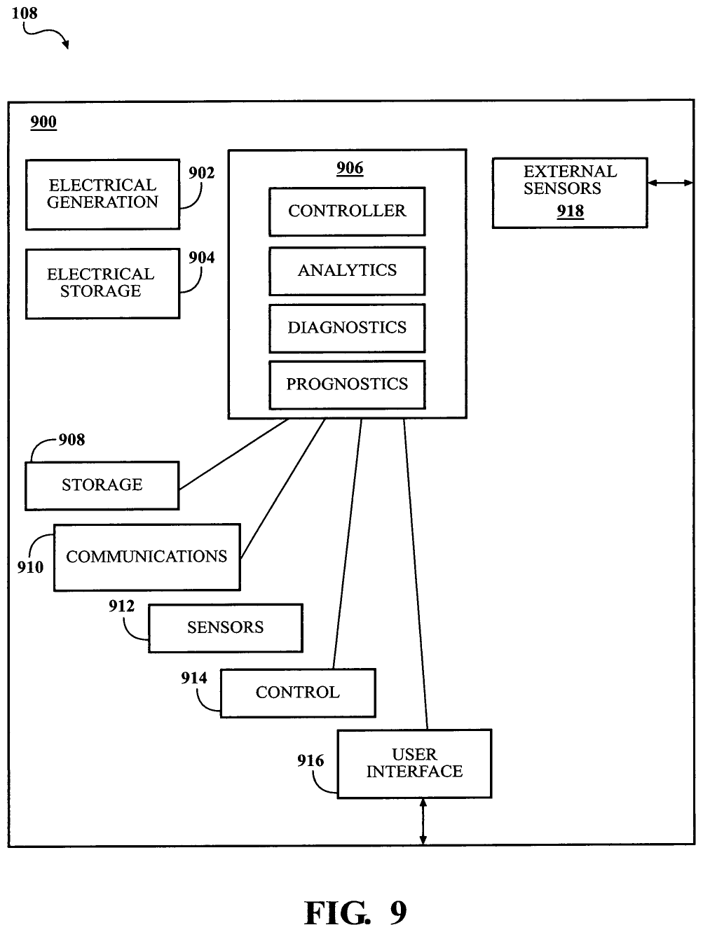

The functional block diagram of FIG. 9 provides a more detailed view of an example embodiment of a monitor, analysis, and control system 108 in accordance with principles of inventive concepts. Monitor, analysis, and control system 108 includes an electrical power system 900, controller 906, electronic storage 908, a communications system 910, sensors 912, control electronics 914, a user interface 916, and an external sensor interface 918.

Electrical power system 900 includes electrical power generator 902 (which may be the same as 212 described in relation to FIG. 2) and electrical power storage system 904 (which may be the same as 207 described in relation to FIG. 2). In example embodiments electrical power system 900 operates in conjunction with a mechanical power generator, as previously described.

Electronic storage 908 may include volatile or non-volatile electronic memory, such as ROM, EEPROM, Flash, DRAM, phase-change, or other memory. Electronic storage 908 may store sensor readings; controller calculations, analyses, diagnostics, and prognostics; information obtained through user interface 916 (commands, updates, etc.); information obtained through communications interface 910, such as sensor readings, analytics results, diagnostics and prognostics from one or more other monitor, analysis, and control systems 108 associated with the same vehicle as the instant monitor, analysis, and control system 108; or information or commands from remote devices, such as fleet server 106 or portable communications device 110, for example, through cloud 104.

Communications interface 910 may employ any of a variety of formats and technologies to provide communications among monitor, analysis, and control systems 108 associated with a particular vehicle or, directly or through the cloud, with portable devices or fleet server, for example.

Sensors 912 provide readings on tire pressure, tire temperature, motion (e.g., three dimensional accelerometer), wheel temperature, ambient pressure, ambient temperature, wheel temperature, for example Sensor readings may be employed by controller 906 in analytics, diagnostics and prognostics, as described in greater detail herein.

Control electronics may include electromechanical devices, such as solenoids or solenoid valves, employed by controller 906 to control gas flow into or out of tires to thereby ensure proper tire inflation for load-leveling, for proper tire wear, for fuel efficiency, and for safe vehicle operation, for example.

User interface 916 allows a user, such as a vehicle operator, to securely query, adjust, or command a monitor, analysis, and control system 108. Input and output through the user interface 916 may employ audio, touchpad, keyboard, stylus, via a standard interface (e.g., USB port), and display, for example.

Controller 906 may be implemented, at least in part, using a microprocessor, microcontroller, application specific processor, system on a chip, or digital signal processor, for example. Controller 906, in addition to controlling the sampling of sensors 917, performs analyses, diagnostics, and prognostics, as described in greater detail herein.

External sensor interface 918 provides communications with sensors that may be external to monitor, analysis, and control system 108 for example.

An alternative unit in which only mechanical energy harvesting is desired, and electrical power generation is not required, may be created by replacing the generator assembly 105 with a shaft assembly (105a), not shown. Such an embodiment could provide the support shaft aspects of the electrical generator embodiment without the need for the added cost and complexity of the electrical power generation aspects of said embodiment.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A vehicle wheel-end energy harvester, comprising:
a non-rotating element;
a rotatable element coupled to a wheel;
a transmission system including non-circular and non-centered gears; and
an engagement element to couple the non-rotating element to the rotatable element, wherein the non-rotating element generates a torque when engaged with the rotatable element and the rotatable element is rotating and the transmission system transmits the torque in the form of usable energy.

2. The vehicle wheel-end energy harvester of claim 1, wherein the usable energy is mechanical energy.

3. The vehicle wheel-end energy harvester of claim 2, wherein the mechanical energy is employed to operate a fluid pumping system.

4. The vehicle wheel-end energy harvester of claim 3, wherein the mechanical energy is engaged to operate a valve in the fluid pumping system.

5. The vehicle wheel-end energy harvester of claim 3, wherein the mechanical energy is employed to inflate a tire associated with the wheel-end.

6. The vehicle wheel-end energy harvester of claim 3, wherein the mechanical energy is employed to deflate a tire associated with the wheel-end.

7. The vehicle wheel-end energy harvester of claim 3, wherein the mechanical energy is employed to store energy in a reservoir of pressurized fluid.

8. The vehicle wheel-end energy harvester of claim 1, wherein the usable energy is electrical energy.

9. The vehicle wheel-end energy harvester of claim 8, wherein the electrical energy is employed to control a wheel-end monitor, analysis and control system.

10. The vehicle wheel-end energy harvester of claim 8, wherein electrical energy is stored in an electrical storage system.

11. The vehicle wheel-end energy harvester of claim 8, wherein the electrical energy is employed to operate a valve in a fluid pumping system.

12. The vehicle wheel-end energy harvester of claim 1, wherein the non-rotating element is a weighted pendulum.

13. A method of harvesting energy at the wheel-end of a wheeled vehicle, comprising:
coupling a rotatable element to a wheel;
engaging the rotatable element through a transmission system to a non-rotating element; and
converting the torque generated by engagement of the rotatable and non-rotating elements to usable energy.

14. The method of claim 13, wherein the usable energy is mechanical energy.

15. The method of claim 14, wherein the mechanical energy is employed to operate a fluid pumping system and to inflate or deflate a tire associated with a wheel-end.

16. The method of claim 13, wherein the usable energy is electrical energy employed to power an electronic wheel-end monitoring system.

17. A wheel-end system for a wheeled vehicle employing inflatable tires, comprising:
a controller to control the inflation of a tire associated with a wheel-end to which the wheel-end system is coupled; and
an energy harvester to supply power to the controller, the energy harvester including:
a rotatable element coupled to a wheel;
a transmission system; and
an engagement element to couple the non-rotating element to the rotatable element, wherein the non-rotating element generates a torque when engaged with the rotatable element and the rotatable element is rotating and the transmission system transmits the torque in the form of usable energy.

18. The wheel-end system of claim 17, wherein the energy harvester generates usable energy in the form of mechanical and electrical energy employed by the wheel-end system to monitor, analyze, and control elements of the wheel-end environment.

19. The wheel-end system of claim 18, wherein electrical energy is employed by a controller to sense wheel-end sensor readings, to analyze those readings and to employ the results of the analysis to control aspects of the wheel-end system.

20. The wheel-end system of claim 19, wherein controlled aspects of the wheel-end system include inflation and deflation of a tire associated with the wheel-end.

21. The wheel-end system of claim 17, wherein the transmission system includes an elevator component that links the non-rotating element to transmit torque.
